(19) United States
(12) Patent Application Publication
(10) Pub. No.: US 2006/0082838 A1
(43) Pub. Date: Apr. 20, 2006

(54) Carriage used in image scanning devices

(76) Inventors: Ming-Der Chou, Taipei (TW); Jung-Chiao Chang, Taipei (TW)

Correspondence Address: HARNESS, DICKEY & PIERCE, P.L.C., P.O. BOX 8910, RESTON, VA, 20195, US

(21) Appl. No.: 10/965,827

(22) Filed: Oct. 18, 2004

(51) Int. Cl. H04N 1/04

(52) U.S. Cl. 358/474

(57) ABSTRACT

A carriage used in image scanning devices includes an optical device installed on the beam path of an illuminating unit, producing a first projection beam and a second projection beam. A first projection unit and a second projection unit are used to transmit the two projection beams to a document to be scanned. An image capture unit is employed to receive the reflective beam from the document and generate image data. Since a single illuminating unit can provide two beams, the invention has the advantage of a simple structure and a low production cost.

### BACKGROUND OF THE INVENTION

1. Field of Invention

The invention relates to a carriage used in image scanning devices such as scanners, copiers, and MFP's. In particular, the invention relates to a carriage for image scanning devices that uses only a single light source to provide two beams.

2. Related Art

People have made a lot of progress in electronic products in recent years. In particular, image scanning devices such as scanners, copiers, and multi-functional peripherals (MFP's) that combine the functions of the above-mentioned two devices and connect to computer devices have been widely used.

The basic operation principle of the image scanning devices is as follows. First, a document to be scanned is put on the device. A transmission mechanism drives a carriage composed of an image capture device and a light source to have a linear motion, generating an axial displacement. The beam from the light source hits the document to produce a reflective beam. The image capture device receives the reflected beam and converts it into an electrical signal, which is in turn transmitted to a printing module for printing.

We further discuss the composition of the carriage on an image scanning device. Most of them use either the charge coupled device (CCD) or the contact image sensor (CIS) as the image capture device. The light sources can be selected from fluorescent tubes, arrayed light-emitting diodes (LED's), and cathode tubes.

The configuration of a conventional carriage is shown in FIG. 1. The light source 20 is next to the image capture device 10. Using a transmission mechanism hidden inside the image scanning device 40, the carriage 30 is driven to produce an axial displacement to scan data on the document.

In practice, most carriages 30 on the market are equipped with only a single light source 20. Thus, the document receiving only light from one direction will produce a shadow, resulting in erroneous reading in image scanning.

In view of the problem, an existing solution is to install another light source 21 on the other side of the image capture device 10 so that the document receives the illumination of two beams. Although this method can improve the situation, the volume and weight of the carriage 30 increase because of the additional light source.

In the field of illumination, there are many improved techniques disclosed, such as the U.S. Pat. No. 5,768,663 (hereinafter referred as the patent 663), U.S. Pat. No. 6,046,826 (hereinafter referred as the patent 826), and U.S. Pat. No. 6,249,368 (hereinafter referred as the patent 368).

The patent 663 has the feature that a U-shape light source module is installed at different angular positions. The symmetric tubes of the U-shape light source module further have different relative bending angles. The patent 826 also uses a similar U-shape light source module. The patent 368 improves the tube base, so that the beam leaves the opening of the specially designed tube base to render a better illumination quality.

In spite of the fact that the above-mentioned patents can operate reasonably and achieve certain effects, the problem of shadows on the document is still not totally solved. Moreover, the prior art also has the design of using arrayed semiconductor lasers and multiple optical devices to provide an arrayed light source, as disclosed in the U.S. Pat. No. 6,130,701. Nevertheless, it still has the problems of a complicated structure and a higher cost.

### SUMMARY OF THE INVENTION

Therefore, the invention discloses a carriage for image scanning devices. A primary objective is to provide a carriage with a simple structure, a low product cost, and using a single light source to provide two projection beams.

The disclosed carriage includes an illuminating unit to produce a beam. An optical device is provided on one side of the illuminating unit to separate the outgoing beam into a first projection beam traveling along a first optical path and a second projection beam traveling along a second optical path. A first projection unit and a second projection unit are installed on the first optical path and the second optical path to transmit the first projection beam and the second projection beam, respectively. The invention further contains an image capture unit installed between the first projection unit and the second projection unit. The beam reflected by the document due to the first projection beam and the second projection beam is received by the image capture unit, producing image data for printing or subsequent processing.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the conventional image scanning device;

FIG. 2 is a schematic view of the optical path in the invention; and

FIG. 3 is another schematic view of the optical path in the invention.

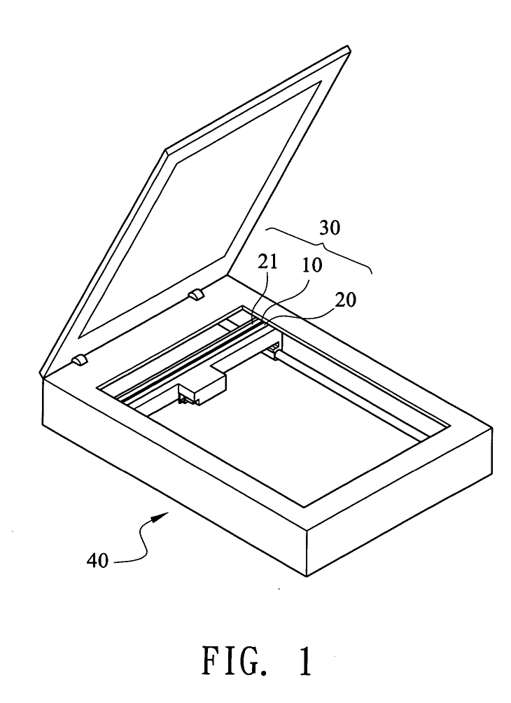

### DETAILED DESCRIPTION OF THE INVENTION

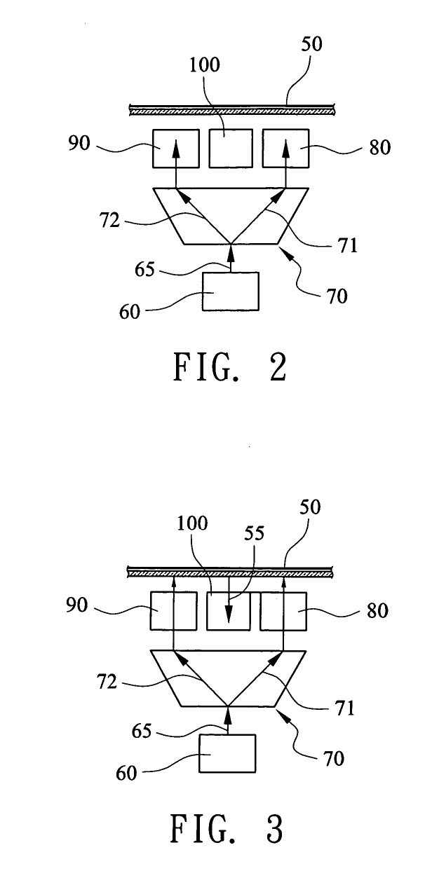

The disclosed carriage for image scanning devices is depicted in FIGS. 2 and 3. It can be used in such image scanning devices as scanners, copiers, and MFP's. The technology of producing various kinds of devices in the image scanning devices is already mature and not the essence of the invention. Therefore, we do not show them in the drawings. Only the relevant components are shown.

The carriage disclosed herein mainly contains an illuminating unit 60, an optical device 70, a first projection unit 80, a second projection unit 90, and an image capture unit 100. The illuminating unit 60 has different forms for different types of image scanning devices, such as the commonly used arrayed light-emitting diodes (LED's), fluorescent tubes, and cathode tubes. One may also use the better photomultiplier tubes. The main function of the illuminating unit 60 is to provide an illuminating beam 65. The optical device 70 is installed on the path of the illuminating beam 65 to separate it into a first projection beam 71 and a second projection beam 72. There are many choices for the optical device 70, including beam splitters, prisms, and gratings. The paths of the two projection beams do not interfere, a first optical path for the first projection beam 71 and a second optical path for the second projection beam 72. The two projection beams are transmitted by the first projection unit 80 and the second projection unit 90, respectively, to emit in parallel and hit the document 50 to be scanned.

The image capture unit 100 is a contact image sensor (CIS) installed between the first projection unit 80 and the second projection unit 90. The document 50 hit by the first projection beam 71 and the second projection beam 72 produces a reflected beam 55, received by the image capture unit 100 to generate image data for copying, image editing, storage or output for subsequent processing. It should be emphasized that both sides of the image capture unit 100 are illuminated by the first projection beam 71 and the second projection beam 72. This makes the reflection from the document 50 more homogeneous and solves the shadow problem in the prior art. Not only is the scanning quality better, the invention also has a simpler structure with components easily assembled at a lower cost.

Certain variations would be apparent to those skilled in the art, which variations are considered within the spirit and scope of the claimed invention.

What is claimed is:

1. A carriage for image scanning devices, comprising:
an illuminating unit, which produces an illuminating beam;
an optical device, which is provided on one side of the illuminating unit to separate the illuminating beam into a first projection beam traveling along a first optical path and a second projection beam traveling along a second optical path;
a first projection unit, which is provided on the first optical path to transmit the first projection beam;
a second projection unit, which is provided on the second optical path to transmit the second projection beam; and
an image capture unit, which is installed between the first projection unit and the second projection unit to receive the beam reflected by a document to be scanned due to the first projection beam and the second projection beam, generating image data.

2. The carriage for image scanning devices of claim 1, wherein the optical device is a beam splitter.

3. The carriage for image scanning devices of claim 1, wherein the optical device is a prism.

4. The carriage for image scanning devices of claim 1, wherein the optical device is a grating.

5. The carriage for image scanning devices of claim 1, wherein the image capture unit is a contact image sensor (CIS).

6. The carriage for image scanning devices of claim 1, wherein the illuminating unit is an array of light-emitting diodes.

7. The carriage for image scanning devices of claim 1, wherein the illuminating unit is a photomultiplier tube.
